(19) United States
(12) Patent Application Publication
(10) Pub. No.: US 2026/0022042 A1
(43) Pub. Date: Jan. 22, 2026

(54) AMPHOTERIC SURFACTANTS FOR INJECTIVITY ENHANCEMENT IN SALTWATER DISPOSAL WELLS

(71) Applicant: CHEMTREAT, INC., Glen Allen, VA (US)

(72) Inventors: Patrick WOOD, Midlothian, VA (US); Robert Rabe, Tuscon, AZ (US); Jayson Burrow, Burnet, TX (US)

(73) Assignee: CHEMTREAT, INC., Glen Allen, VA (US)

(21) Appl. No.: 18/774,398

(22) Filed: Jul. 16, 2024

(51) Int. Cl. C02F 1/54; C02F 101/20; C02F 101/32; C02F 103/06; C02F 103/34

(52) U.S. Cl. CPC C02F 1/542; C02F 1/547; C02F 2101/203; C02F 2101/32; C02F 2103/06; C02F 2103/34; C02F 2303/22; C02F 2305/04

(57) ABSTRACT

A method for treating water includes adding an alkyl amphocarboxylate and an organic chelating agent to the water. Furthermore, a composition includes disodium cocoamphodiacetate in an amount in the range of from 0.1 to 10.0 wt %; an organic chelating agent in an amount in the range of from 1.0 to 50.0 wt %; and water.

### BACKGROUND

Saltwater, or produced water, is a byproduct of natural gas and oil production; it comes up simultaneously with the production of oil and gas. Produced water can have varying levels of salinity based on the geologic formations that produce the oil and gas. Small quantities of substances used in the drilling, completion, and production operations of a well may be present in the produced water. Such materials include drilling mud, fracture fluids, and well treatment fluids. Also, because the produced water is associated with crude oil and natural gas, small amounts of residual hydrocarbons may also be found in the produced water. As a result, the produced water is heavily polluted with salt, hydrocarbons, and industrial compounds, and is therefore hazardous to the environment. Its disposal is therefore tightly regulated.

One way to manage produced water is to inject it back into the ground. Saltwater disposal wells are specifically designed to safely dispose of produced water from oil and gas drilling operations. There are several benefits to using them over other methods of wastewater management, such as:
Saltwater disposal wells can be located on-site, reducing transportation costs and spills risk.
Injecting produced water deep underground helps to keep it away from surface waterways and drinking water supplies.
Produced water must be treated to enhance the quality for reinjection into disposal wells, so that pressure increases are minimized and/or daily injection volumes are maintained or not negatively impacted.
   Today there are approximately 30,000 saltwater disposal wells in operation in the United States.

Produced water is prone to iron, scale, and other suspended solids fouling in the formation and, as mentioned above, typically has high levels of residual hydrocarbon or oils. These oils coat solids present in the produced water. The removal and dispersion of these oils helps to improve injectivity and allows for the redisolution of inorganic solids.

Due to the volume of produced water generated by oil and gas production, even small improvements in injection efficiency can have a significant effect in reducing pressure buildup and mitigating maintenance costs. Accordingly, much effort has gone in to removing suspended solids in produced water.

Existing methods for treating produced water include introducing organic chelating agents, which can prevent formation of solid particulates such as iron oxide and iron sulfide, and dissolve or break down any such particulates that are already present. However, the organic chelating agents cannot penetrate through the oily layer that typically forms around the suspended solids in the presence of hydrocarbons.

Some attempts have been made to address this problem by introducing surfactants that can destabilize and disperse the oily layer. However, commonly used surfactants have been found to interfere with the chelating agents and scaling inhibitors present in the produced water, counteracting the effectiveness of these other treatment methods.

Accordingly, there is an ongoing need to development treatment solutions that effectively allow for the removal of oily suspended solids without hampering the action of chelating agents and scaling inhibitors.

### SUMMARY

It is an object of the disclosed embodiments to provide an effective solution for the removal of oily suspended solids in produced water without interfering with the action of chelating agents and scaling inhibitors

In one aspect, this disclosure provide a method for treating water. The method comprises adding an alkyl amphocarboxylate and an organic chelating agent to the water.

In another aspect, this disclosure provides a composition includes disodium cocoamphodiacetate in an amount in the range of from 0.1 to 10.0 wt %; an organic chelating agent in an amount in the range of from 1.0 to 50.0 wt %; and water.

### DETAILED DESCRIPTION OF EMBODIMENTS

The inventors conducted detailed studies and found that the addition of alkyl amphocarboxylates to produced water provides a surprising improvement in injectivity of the produced water without interfering with the action of any chelants or scale inhibitors being fed to the produced water.

Without being bound by theory, it is believed that amphoteric nature of the chemistry provides better detergency, and the presence of the carboxylate group in alkyl amphocarboxylates improves compatibility with other species that may be present in the produced water. This is because anionic species (such as that formed by dissociation of a carboxylate group) can be better suited towards dispersing inorganic solids such as iron oxide, iron sulfide, and iron carbonate.

This is in contrast to other surfactants, such as cationics and quaternary ammonium compounds (so-called “quats”), including alkylmethylbenzylammonium chloride (ADBAC) and betaines. Amines/quats typically have minimal affinity towards inorganic deposits, and usually only act as a dispersant for organic material. Additionally, these other surfactants have been found to interfere with scale inhibitors and organic acids, which are anionic. Alkyl amphocarboxylates lack a quaternary amine group, and are therefore less likely to deactivate anionic species that are needed to increase injectivity.

Accordingly, the disclosed embodiments include a treatment composition for treating produced water. The treatment composition includes an alkyl amphocarboxylate. The alkyl amphocarboxylate may be, for example, disodium cocoamphodoacetate. The alkyl amphocarboxylate can be included in the treatment composition in an amount in the range of from 0.1 to 10.0 wt %, from 0.3 to 5.0 wt %, or from 0.5 to 1.0 wt %, for example.

The treatment composition can comprise the alkyl amphocarboxylate in water, for example. An amount of water in the treatment composition can be in the range of from 40 to 95 wt %, 50 to 90 wt %, 60 to 85 wt %, or 70 to 80 wt %, for example.

The treatment composition can further include other components, such as an organic chelating agent. The organic chelating agent is not limited and can be, for example, tetrakis(hydroxymethyl)phosphonium sulfate (THPS), citric acid, acetic acid, glycolic acid, thioglycolic acid, ethylenediamine tetraacetic acid (EDTA), tetrasodium glutamate diacetate (GLDA), nitrilotriacetic acid (NTA), or diethylenetriaminepentaacetic acid (DTPA). An amount of the organic chelating agent in the treatment composition can be in the range of from 0.1 to 50.0 wt %, 0.5 to 40.0 wt %, or 1.0 to 30.0 wt %, for example. A weight ratio of the alkyl amphocarboxylate to the organic chelating agent in the treatment composition is, for example, 1:30, 1:20, 1:15, 1:10, 1:5, or 1:3.

The treatment composition can further include a scale inhibitor. The scale inhibitor is not limited and can be an organic acid, such as citric acid, acetic acid, 2-phosphonobutane 1,2,4-tricarboxylic acid (PBTC), diethylenetriaminepenta (methylene phosphonic acid) (DETPMP), bis-hexamethylene-triamine-pentamethylene phosphonic acid (BHTPMP), nitrilotrimethylphosphonic acid (NTP), or polyaspartic acid; or a polymer such as polyacrylic acid polymer (PAA) or a copolymer or terpolymer of acrylic acid and 2-acrylanmido-2-methylpropanesulfonic acid (AA/AMPS). The amount of scale inhibitor in the treatment composition can be in the range of from 1.0 to 50.0 wt %, 5.0 to 40.0 wt %, or 10.0 to 30.0 wt %, for example. A weight ratio of the alkyl amphocarboxylate to the scale inhibitor in the treatment composition is, for example, 1:30, 1:20, 1:15, 1:10, 1:5, or 1:3.

The treatment composition preferably does not include any cationic surfactants or quaternary ammonium compounds.

In some embodiments, the treatment composition includes only the alkyl amphocarboxylate and water, and the organic chelating agent and scale inhibitor are added to the produced water separately from the alkyl amphocarboxylate. For example, the organic chelating agent and scale inhibitor can be administered at the same application point as the treatment composition, but separately from the treatment composition. The treatment composition, organic chelating agent, and scale inhibitor can be administered concurrently or sequentially. Alternatively, the treatment composition, organic chelating agent, and scale inhibitor can each be administered separately as needed.

The treatment composition can be administered at various application points in the saltwater disposal system, or even upstream of the saltwater disposal system. For example, the treatment composition can be administered:
1) upstream of the saltwater disposal system, in the pipeline right after the separation equipment used to separate the crude oil from the produced water;
2) at the inlet to the saltwater disposal system, and/or
3) at the outlet of the saltwater disposal system, prior to reinjection of the produced water.

### EXAMPLES

The following studies were performed to investigate the effectiveness of the treatment compositions and methods of the disclosed embodiments.

### Example 1

A number of different surfactants were evaluated for the effectiveness in improving the injectivity of produced water. Testing was performed using a standard field millipore analysis where produced water in the field was filtered through a 0.45 μm filter. The time to filter and amount filtered were documented and used as a metric for improved injectivity. A decrease in time to filter, measured as an increase in filtered volume over the course of 3 minutes, reflected an improvement in injectvity.

The results for two produced water samples are summarized in Table 1 below. Some surfactants were tested in only a single produced water sample based on demands at the time of testing.

TABLE 1

| | | Produced Water #1 | Produced Water #2 |
|---|---|---|---|
| Sample | 5 ppm Active | milliliters/3 minutes | milliliters/3 minutes |
| Blank | none | 115 | 120 |
| 0 | Nonylphenol Ethoxylate (9.5) | 180 | 240 |
| 1 | ADBAC quat (coco) | 210 | |
| 2 | Amido Quat (coco) | 190 | |
| 3 | Oxydiethylene Bis-Quat (coco) | 235 | |
| 4 | Alkyl Etherhydroxypropyl Sultaine | 220 | |
| 5 | Soy Amidopropyl Ammonium Chloride | 210 | |
| 6 | Didecyldimethylammonium Chloride | 225 | |
| 7 | ADBAC | 250 | 125 |
| 8 | Alpha Olefin Sulfonate | 195 | |
| 9 | Octylphenol Ethoxylate (9.5) | 225 | |
| 10 | Tallowamine DES quat ethoxylate (15) | 225 | |
| 11 | Lauramidopropyl Betaine | 255 | 120 |
| 12 | Disodium Cocoamphodiacetate | 255 | 200 |
| 13 | Cocoamidopropyl Hydroxysultaine | 230 | |
| 14 | Decyl alcohol Ethoxylate | 250 | 150 |
| 15 | Tetrasodium Dicarboxyethyl Stearyl Sulfosuccinamate | 250 | 150 |
| 16 | Capramidopropyldimethyl Betaine | 250 | 130 |
| 17 | Cocoalkylmiethyl PEG-15 Ammonium Chloride | 260 | 200 |
| 18 | Sodium DDBSA | 275 | 135 |
| 19 | Sodium Dicarboxyethyl Coco Phosphoethyl Imidazoline | 270 | 195 |
| 21 | Alkyl Ether Carboxylate (6) | | 140 |
| 22 | Cocoamidopropyl Betaine | | 150 |

Overall across samples, amphocarboxylates showed consistently the best improvement to injectivity.

### Example 2

Different sample formulations were prepared using 1 wt % of different surfactants, as indicated in Table 2 below, and passed through a 0.45 μm filter as discussed above. The effectiveness of the different surfactants was compared across compositions including varying amounts of chelating agents.

To measure the effectiveness of the surfactants, the formulations were dosed into produced water samples at a dosage of 50 ppm. Filtration was allowed to proceed for 180 seconds or until the sample had finished filtering (if completed in less than 180 seconds). The volume of filtered produced water was then measured. A decrease in time to filter, measured as an increase in filtered volume per unit time, reflected an improvement in injectvity.

It was found that disodium cocoamphodoacetate (an alkyl amphocarboxylate) provided the best results across all sample formulations, allowing the largest volume per unit time. The increased flow of fluid through the filter correlates with improved injectivity of the produced water.

TABLE 2

| Treatment | | Other Components (wt %) | | | | |
|---|---|---|---|---|---|---|
| Composition | | | Citric | Acetic | Time | Volume |
| Dosage | Surfactant, 1 wt % | THPS | Acid | Acid | (sec) | (mL) |
| 50 | NONE | 20 | 5 | 0 | 180 | 250 |
| 50 | Nonylphenol Ethoxylate (9.5) | 20 | 5 | 0 | 90 | 300 |
| 50 | Disodium Cocoamphodiacetate | 20 | 5 | 0 | 79 | 300 |
| 50 | NONE | 0 | 0 | 56 | 180 | 200 |
| 50 | Nonylphenol Ethoxylate (9.5) | 0 | 0 | 56 | 165 | 300 |
| 50 | Disodium Cocoamphodiacetate | 0 | 0 | 56 | 180 | 260 |
| 50 | Nonylphenol Ethoxylate (9.5) | 10 | 6 | 0 | 112 | 300 |
| 50 | Disodium Cocoamphodiacetate | 10 | 6 | 0 | 98 | 300 |
| 50 | Nonylphenol Ethoxylate (9.5) | 5 | 15 | 0 | 92 | 300 |
| 50 | Disodium Cocoamphodiacetate | 5 | 15 | 0 | 74 | 300 |
| 50 | Nonylphenol Ethoxylate (9.5) | 10 | 0 | 20 | 180 | 235 |
| 50 | Disodium Cocoamphodiacetate | 10 | 0 | 20 | 180 | 175 |
| 50 | Nonylphenol Ethoxylate (9.5) | 0 | 10 | 20 | 123 | 300 |
| 50 | Disodium Cocoamphodiacetate | 0 | 10 | 20 | 180 | 300 |
| 50 | Nonylphenol Ethoxylate (9.5) | 7.5 | 7.5 | 20 | 180 | 265 |
| 50 | Disodium Cocoamphodiacetate | 7.5 | 7.5 | 20 | 180 | 285 |

### Example 3

Different sample formulations were prepared using 1 wt % of different surfactants, as indicated in Table 3 below, and passed through a 0.45 μm filter as discussed above. The effectiveness of the different surfactants was compared across compositions including varying amounts of chelating agents.

To measure the effectiveness of the surfactants, the formulations were dosed into produced water samples at a dosage of either 25 ppm or 50 ppm. Filtration was allowed to proceed for 180 seconds or until the sample had finished filtering (if completed in less than 180 seconds). The volume of filtered produced water was then measured. A decrease in time to filter, measured as an increase in filtered volume per unit time, reflected an improvement in injectvity.

It was found that disodium cocoamphodoacetate (an alkyl amphocarboxylate) provided the best results across all sample formulations, allowing the largest volume per unit time. The increased flow of fluid through the filter correlates with improved injectivity of the produced water.

TABLE 3

| Treatment | | Other Components (wt %) | | | | |
|---|---|---|---|---|---|---|
| Composition | | | Citric | Acetic | Time | Volume |
| Dosage | Surfactant, 1 wt % | THPS | Acid | Acid | (sec) | (mL) |
| 25 | Cocoalkylmiethyl PEG-15 Ammonium Chloride | 5 | 15 | 0 | 180 | 75 |
| 50 | Cocoalkylmiethyl PEG-15 Ammonium Chloride | 5 | 15 | 0 | 180 | 105 |
| 25 | Disodium Cocoamphodiacetate | 5 | 15 | 0 | 180 | 110 |
| 50 | Disodium Cocoamphodiacetate | 5 | 15 | 0 | 180 | 110 |
| 25 | Sodium Dicarboxyethyl Coco Phosphoethyl Imidazoline | 5 | 15 | 0 | 180 | 75 |
| 50 | Sodium Dicarboxyethyl Coco Phosphoethyl Imidazoline | 5 | 15 | 0 | 180 | 95 |
| 25 | Cocoamidopropyl Betaine | 5 | 15 | 0 | 180 | 55 |
| 50 | Cocoamidopropyl Betaine | 5 | 15 | 0 | 180 | 60 |
| 25 | Nonylphenol Ethoxylate (9.5) | 5 | 15 | 0 | 180 | 65 |
| 50 | Nonylphenol Ethoxylate (9.5) | 5 | 15 | 0 | 180 | 50 |
| 25 | Cocoalkylmiethyl PEG-15 Ammonium Chloride | 10 | 0 | 20 | 180 | 130 |
| 50 | Cocoalkylmiethyl PEG-15 Ammonium Chloride | 10 | 0 | 20 | 180 | 130 |
| 25 | Disodium Cocoamphodiacetate | 10 | 0 | 20 | 180 | 140 |
| 50 | Disodium Cocoamphodiacetate | 10 | 0 | 20 | 180 | 150 |
| 25 | Sodium Dicarboxyethyl Coco Phosphoethyl Imidazoline | 10 | 0 | 20 | 180 | 135 |
| 50 | Sodium Dicarboxyethyl Coco Phosphoethyl Imidazoline | 10 | 0 | 20 | 180 | 135 |
| 25 | Cocoamidopropyl Betaine | 10 | 0 | 20 | 180 | 135 |
| 50 | Cocoamidopropyl Betaine | 10 | 0 | 20 | 180 | 140 |
| 25 | Nonylphenol Ethoxylate (9.5) | 10 | 0 | 20 | 180 | 145 |
| 50 | Nonylphenol Ethoxylate (9.5) | 10 | 0 | 20 | 180 | 145 |

It will be appreciated that the above-disclosed features and functions, or alternatives thereof, may be desirably combined into different compositions and methods. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A method for treating water, the method comprising:
adding an alkyl amphocarboxylate and an organic chelating agent to the water.

2. The method of claim 1, wherein the alkyl amphocarboxylate is disodium cocoamphodiacetate.

3. The method of claim 1, wherein the organic chelating agent is selected from the group consisting of tetrakis(hydroxymethyl)phosphonium sulfate (THPS), citric acid, acetic acid, glycolic acid, thioglycolic acid, ethylenediamine tetraacetic acid (EDTA), tetrasodium glutamate diacetate (GLDA), nitrilotriacetic acid (NTA), and diethylenetriaminepentaacetic acid (DTPA).

4. The method of claim 1, wherein the organic chelating agent is tetrakis(hydroxymethyl)phosphonium sulfate (THPS).

5. The method of claim 1, wherein the water is produced water generated during oil and gas production.

6. The method of claim 1, wherein the water includes hydrocarbons and suspended solids before the alkyl amphocarboxylate is added.

7. The method of claim 1, wherein a weight ratio of the alkyl amphocarboxylate to the organic chelating agent added to the water is in the range of 1:30 to 1:3

8. The method of claim 1, wherein the alkyl amphocarboxylate and the organic chelating agent are added to the water together in the form of a treatment composition.

9. The method of claim 8 wherein:
an amount of the alkyl amphocarboxylate in the treatment composition is in the range of from 0.1 to 10.0 wt %; and
an amount of the organic chelating agent in the treatment composition is in the range of from 1.0 to 50.0 wt %.

10. The method of claim 1, further comprising adding a scale inhibitor.

11. The method of claim 10, wherein the scale inhibitor is selected from the group consisting of citric acid, acetic acid, 2-phosphonobutane 1,2,4-tricarboxylic acid (PBTC), diethylenetriaminepenta (methylene phosphonic acid) (DETPMP), bis-hexamethylene-triamine-pentamethylene phosphonic acid (BHTPMP), nitrilotrimethylphosphonic acid (NTP), polyaspartic acid, polyacrylic acid polymer (PAA), and a copolymer or terpolymer of acrylic acid and 2-acrylanmido-2-methylpropanesulfonic acid (AA/AMPS).

12. The method of claim 10, wherein the alkyl amphocarboxylate, the organic chelating agent, and the scale inhibitor are added to the water together in the form of a treatment composition.

13. The method of claim 12, wherein:
an amount of the alkyl amphocarboxylate in the treatment composition is in the range of from 0.1 to 10.0 wt %;
an amount of the organic chelating agent in the treatment composition is in the range of from 1.0 to 50.0 wt %; and
an amount of the scale inhibitor in the treatment composition is in the range of from 1.0 to 50.0 wt %.

14. A composition comprising:
disodium cocoamphodiacetate in an amount in the range of from 0.1 to 10.0 wt %;
an organic chelating agent in an amount in the range of from 1.0 to 50.0 wt %; and
water.

15. The composition of claim 14, wherein the organic chelating agent is selected from the group consisting of tetrakis(hydroxymethyl)phosphonium sulfate (THPS), citric acid, acetic acid, glycolic acid, thioglycolic acid, ethylenediamine tetraacetic acid (EDTA), tetrasodium glutamate diacetate (GLDA), nitrilotriacetic acid (NTA), and diethylenetriaminepentaacetic acid (DTPA).

16. The composition of claim 14, wherein the organic chelating agent is tetrakis(hydroxymethyl)phosphonium sulfate.

17. The composition of claim 14, further comprising a scale inhibitor.

18. The composition of claim 14, wherein the scale inhibitor is selected from the group consisting of citric acid, acetic acid, 2-phosphonobutane 1,2,4-tricarboxylic acid (PBTC), diethylenetriaminepenta (methylene phosphonic acid) (DETPMP), bis-hexamethylene-triamine-pentamethylene phosphonic acid (BHTPMP), nitrilotrimethylphosphonic acid (NTP), polyaspartic acid, polyacrylic acid polymer (PAA), and a copolymer or terpolymer of acrylic acid and 2-acrylanmido-2-methylpropanesulfonic acid (AA/AMPS).

19. The composition of claim 17, wherein an amount of the scale inhibitor in the composition is in the range of from 1.0 to 50.0 wt %.
